(19) United States
(12) Patent Application Publication
(10) Pub. No.: US 2009/0252959 A1
(43) Pub. Date: Oct. 8, 2009

(54) CROSS-LINKABLE PRESSURE-SENSITIVE ADHESIVE FOR DETACHABLE SOFT PVC SUPPORTS

(75) Inventors: Karl-Heinz Schumacher, Neustadt (DE); Nok-young Choi, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/721,921

(22) PCT Filed: Dec. 14, 2005
(86) PCT No.: PCT/EP2005/013402

§ 371 Date: Jun. 15, 2007

(30) Foreign Application Priority Data
Dec. 17, 2006 (DE) 102004061611.6

(51) Int. Cl. C09J 7/02; B32B 7/12; B05D 5/10; C09J 133/08

(52) U.S. Cl. 428/355 EN; 427/208.4

(57) ABSTRACT

Self-adhesive articles comprising at least one backing and a pressure sensitive adhesive comprising
A) a polymer synthesized from
a) 50 to 99.5% by weight of butyl acrylate
b) 0 to 40% by weight of 2-ethylhexyl acrylate
c) 0 to 5% by weight of an ethylenically unsaturated acid
d) 0.1 to 5% by weight of an ethylenically unsaturated compound having at least one keto or aldehyde group
e) 0 to 30% by weight of further monomers.

The invention relates to self-adhesive articles comprising at least one backing and a pressure sensitive adhesive comprising
A) a polymer synthesized from
a) 50 to 99.5% by weight of butyl acrylate
b) 0 to 40% by weight of 2-ethylhexyl acrylate
c) 0 to 5% by weight of an ethylenically unsaturated acid
d) 0.1 to 5% by weight of an ethylenically unsaturated compound having at least one keto or aldehyde group
e) 0 to 30% by weight of further monomers and
B) a compound which comprises at least two functional groups which with the keto or aldehyde groups enter into a crosslinking reaction.

For exterior applications it is common to use self-adhesive labels and tapes and also printed films comprising plasticized PVC as their backing material. Plasticized PVC films comprise low molecular mass, phthalate-based plasticizers. One problem which may occur as a result of using these plasticizers is plasticizer migration from the film into the pressure sensitive adhesive (PSA). This detracts from adhesive performance.

In the exterior sector, the self-adhesive articles are also subject to the influence of moisture.

The action of water on the film of adhesive may result in an unwanted white haze, called blushing.

Self-adhesive, printed sheets are often used, among other things, for decorative purposes or for advertising, and for that purpose are adhered, for example, to vehicles of all kinds, especially passenger cars, buses, etc.

In the case of many applications it is desired that the sheets can be detached again later without residue.

EP-A 1 378 527 discloses pressure sensitive adhesives for plasticized PVC backings, comprising no crosslinker. WO 93/14161 describes Crosslinkable pressure sensitive adhesives for the same application.

Pressure sensitive adhesives with C₄ alkyl acrylates and C₆ to C₁₂ alkyl acrylates are subject matter of EP-A 952 199.

Adhesives which comprise a crosslinking system comprising dihydrazides and polymers containing keto or aldehyde groups are already known and are described in EP-A 148 386 and in DE-A 101 35 379 (PF52675) for use as laminating adhesives.

An object of the present invention were self-adhesive articles redetachable without residue, comprising plasticized PVC as backing material and featuring good adhesion and cohesion and little blushing.

The self-adhesive articles defined at the outset have been found accordingly.

The self-adhesive articles have a pressure sensitive adhesive which has been coated onto a backing.

The pressure sensitive adhesive comprises as binder the polymer defined at the outset, which is obtainable by free-radical addition polymerization of the monomers a) to e).

The polymer A) is composed of 50 to 99.5% by weight, preferably 50 to 85% by weight, and more preferably 60 to 80% by weight of n-butyl acrylate (monomer a)).

Polymer A) is further composed of 0 to 40% by weight of 2-ethylhexyl acrylate (monomer b)).

Preferably the 2-ethylhexyl acrylate content of polymer A) is at least 5% by weight. With particular preference the fraction of 2-ethylhexyl acrylate is 10 to 40% by weight and with very particular preference 20 to 35% by weight.

The ethylenically unsaturated acid c) can be a sulfonic acid, phosphoric acid or, preferably, carboxylic acid.

Suitable examples include maleic acid, fumaric acid and itaconic acid or, preferably, acrylic and/or methacrylic acid.

The amount of c) is preferably 0 to 3, more preferably 0 to 2% by weight. In particular, monomer c) is present in an amount of at least 0.2% by weight.

Monomers d) are, for example, acrolein, methacrolein, vinyl alkyl ketones having 1 to 20, preferably 1 to 10, carbon atoms in the alkyl radical, formylstyrene, (meth)acrylic acid alkyl esters having one or two keto or aldehyde or one aldehyde and one keto group in the alkyl radical, said alkyl radical comprising preferably, in total, 3 to 10 carbon atoms, examples being (meth)acryloyloxyalkylpropanals, as described in DE-A 2 722 097. Also suitable, furthermore, are N-oxoalkyl(meth)acrylamides such as are known, for example, from U.S. Pat. No. 4,228,007, DE-A 2 061 213 or DE-A 2 207 209.

Particular preference is given to acetoacetyl(meth)acrylate, acetoacetoxyethyl (meth)acrylate and, in particular, diacetone acrylamide.

The amount of monomers d) in the polymer is 0.1 to 5% by weight, preferably 0.1 to 2% by weight and more preferably 0.2 to 1% by weight.

Further monomers e) are, for example, other C₁-C₈ alkyl (meth)acrylates, especially methyl (meth)acrylate, vinyl aromatic compounds, especially styrene, vinyl esters of carboxylic acid, e.g., vinyl acetate, etc.

The amount of further monomers e) can be 0 to 30% by weight, in particular 0 to 10% by weight, or 0 to 5% by weight.

In particular it is possible to do without further monomers, since they are not required for the purposes of the present invention.

In one preferred embodiment polymer A) and also the pressure sensitive adhesive comprises no vinyl esters of carboxylic acids, especially no vinyl acetate.

In one preferred embodiment polymer A) is prepared by emulsion polymerization, and is therefore an emulsion polymer.

In the case of emulsion polymerization, use is made of ionic and/or nonionic emulsifiers and/or protective colloids and/or stabilizers as surface-active compounds.

A detailed description of suitable protective colloids can be found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are normally below 2000 g/mol. Where mixtures of surface-active substances are used, the individual components must of course be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO units: 3 to 50, alkyl: C₈ to C₃₆), ethoxylated mono-, di, and tri-alkylphenols (EO units: 3 to 50, alkyl: C₄ to C₉), alkali metal salts of dialkyl esters of sulfosuccinic acid, and also alkali metal salts and ammonium salts of alkyl sulfates (alkyl: C₈ to C₁₂), of ethoxylated alkanols (EO units: 4 to 30, alkyl: C₁₂ to C₁₈), of ethoxylated alkylphenols (EO units: 3 to 50, alkyl: C₄ to C₉), of alkylsulfonic acids (alkyl: C₁₂ to C₁₈), and of alkylarylsulfonic acids (alkyl: C₉ to C₁₈).

Further suitable emulsifiers are compounds of the general formula II

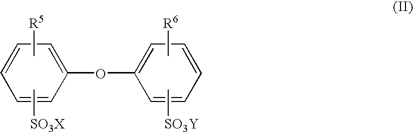

where R⁵ and R⁶ are hydrogen or C₄ to C₁₄ alkyl but are not simultaneously hydrogen, and X and Y can be alkali metal ions and/or ammonium ions. With preference, R⁵ and R⁶ are linear or branched alkyl radicals having from 6 to 18 carbon atoms or hydrogen and in particular have 6, 12 or 16 carbon atoms, R⁵ and R⁶ not both simultaneously being hydrogen. X and Y are preferably sodium, potassium or ammonium ions, sodium being particularly preferred. Particularly advantageous compounds II are those in which X and Y are sodium, R⁵ is a branched alkyl radical of 12 carbon atoms, and R⁶ is hydrogen or R⁵. It is common to use technical mixtures containing a fraction of from 50 to 90% by weight of the monoalkylated product, one example being Dowfax® 2A1 (trade mark of the Dow Chemical Company).

Suitable emulsifiers can also be found in Houben-Weyl, Methoden der organischen Chemie, Volume 14/1, Makromolekulare Stoffe, Georg Thieme Verlag, Stuttgart, 1961, pages 192 to 208.

Examples of emulsifier trade names are Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol VSL, and Emulphor NPS 25.

For the present invention, ionic emulsifiers or protective colloids are preferred. With particular preference these are ionic emulsifiers, especially salts and acids, such as carboxylic acids, sulfonic acids and sulfates, sulfonates or carboxylates.

Preferred emulsifiers are those containing sulfate or sulfonate groups. Particular preference is given to fatty alcohol ether sulfates and to sulfosuccinic esters, and very particular preference is given to mixtures of these two.

The surface-active substance is commonly used in amounts of 0.1 to 10 parts by weight, preferably 0.2 to 5 parts by weight, per 100 parts by weight of the monomers to be polymerized.

Water-soluble initiators for the emulsion polymerization are, for example, ammonium salts and alkali metal salts of peroxodisulfuric acid, e.g., sodium peroxodisulfate, hydrogen peroxide, or organic peroxides, e.g., tert-butyl hydroperoxide.

Also suitable are what are known as reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing component comprises, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxodisulfate, tert-butyl hydroperoxide/sodium disulfite, and tert-butyl hydroperoxide/Na hydroxymethanesulfinate. The individual components, the reducing component for example, may also be mixtures: for example, a mixture of the sodium salt of hydroxymethanesulfinic acid with sodium disulfite.

These compounds are mostly used in the form of aqueous solutions, the lower concentration being determined by the amount of water that is acceptable in the dispersion and the upper concentration by the solubility of the respective compound in water. The concentration is generally from 0.1 to 30% by weight, preferably from 0.5 to 20% by weight, with particular preference from 1.0 to 10% by weight, based on the solution.

The amount of the initiators is generally from 0.1 to 10% by weight, preferably from 0.5 to 5% by weight, based on the monomers to be polymerized. It is also possible for two or more different initiators to be used for the emulsion polymerization.

For the polymerization it is possible to use regulators, in amounts for example of from 0 to 0.8 part by weight per 100 parts by weight of the monomers to be polymerized.

These regulators reduce the molar mass. Suitable examples include compounds containing a thiol group, such as tert-butyl mercaptan, thioglycolic acid ethylacrylic ester, mercaptoethynol, mercaptopropyltrimethoxysilane, and tert-dodecyl mercaptan.

The emulsion polymerization takes place in general at from 30 to 130° C., preferably from 50 to 90° C. The polymerization medium may be composed either of water alone or of mixtures of water and water-miscible liquids such as methanol. Preferably, only water is used. The emulsion polymerization may be conducted either as a batch operation or in the form of a feed process, including staged or gradient procedures. Preference is given to the feed process in which a portion of the polymerization mixture is introduced as an initial charge and heated to the polymerization temperature, the polymerization of this initial charge is begun, and then the remainder of the polymerization mixture is supplied to the polymerization zone, usually by way of two or more spatially separate feed streams, of which one or more comprise the monomers in straight or emulsified form, this addition being made continuously, in stages or under a concentration gradient, and polymerization being maintained during said addition. It is also possible, in order, for example, to set the particle size more effectively, to include a polymer seed in the initial charge to the polymerization.

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove the residual monomers, it is common to add initiator after the end of the actual emulsion polymerization as well, i.e., after a monomer conversion of at least 95%.

With the feed process, the individual components can be added to the reactor from the top, through the side, or from below, through the reactor floor.

In the case of emulsion polymerization, aqueous polymer dispersions with solids contents of generally from 15 to 75% by weight, preferably from 40 to 75% by weight, are obtained.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81083), by adding excess quantities of emulsifier, or by adding miniemulsions. Another advantage associated with the low viscosity at high solids content is the improved coating behavior at high solids contents. One or more new generations of particles can be produced at any point in time. It is guided by the particle size distribution which is targeted for a low viscosity.

The polymer thus prepared is used preferably in the form of its aqueous dispersion.

The average particle size of the polymer particles dispersed in the aqueous dispersion is preferably smaller than 300 nm, in particular smaller than 200 nm. With particular preference the average particle size is situated between 140 and 200 nm.

By average particle size here is meant the d₅₀ value of the particle size distribution, i.e., 50% by weight of the total mass of all particles have a smaller particle diameter than the d₅₀ value. The particle size distribution can be determined conventionally using the analytical ultracentrifuge (W. Mächtle, Makromolekulare Chemie 185 (1984), pages 1025-1039).

The pH of the polymer dispersion is preferably adjusted to a pH of more than 4.5, and in particular to a pH of between 5 and 8.

The glass transition temperature of the polymer, or of the polymer, is preferably from −60 to 0° C., with particular preference from −60 to −10° C., and with very particular preference from −50 to −20° C.

The glass transition temperature can be determined by customary methods such as differential thermoanalysis or differential scanning calorimetry (see, for example, ASTM 3418/82, midpoint temperature).

The pressure sensitive adhesive further comprises the compound B) defined at the outset.

Compound B) has at least 2 functional groups, in particular 2 to 5 functional groups, more preferably 2 or 3 functional groups, very preferably 2 functional groups, which with the keto or aldehyde groups enter into a crosslinking reaction.

Examples of suitable functional groups include hydrazide, hydroxylamine or oxime ether or amino groups. Hydrazide groups are particularly preferred.

Suitable compounds having hydrazide groups are, for example, polycarboxylic hydrazides having a molar weight of up to 500 g/mol.

Particularly preferred hydrazide compounds are dicarboxylic dihydrazides having preferably 2 to 10 carbon atoms.

Examples that may be mentioned include oxalic dihydrazide, malonic dihydrazide, succinic dihydrazide, glutaric dihydrazide, adipic dihydrazide, sebacic dihydrazide, maleic dihydrazide, fumaric dihydrazide, Itaconic dihydrazide and/or isophthalic dihydrazide. The following are of particular interest: adipic dihydrazide, sebacic dihydrazide, and isophthalic dihydrazide.

Suitable compounds containing hydroxylamine groups or oxime ether groups are specified for example in WO 93/25588.

These are, for example, hydroxylamine derivatives of the general formula

(H₂N—O)−₂A I,

in which A is a saturated or unsaturated aliphatic, linear or branched hydrocarbon radical of 2 to 12 carbon atoms, which may be interrupted by 1 to 3 nonadjacent oxygen atoms, and n is 2, 3 or 4, or oxime ethers of the formula

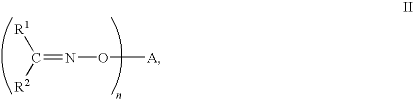

in which A and n are as defined above and R¹ and R² independently of one another are a C₁-C₁₀ alkyl, C₁-C₁₀ alkoxy or C₅-C₁₀ aryl radical, which may also comprise 1 to 3 nonadjacent nitrogen, oxygen or sulfur atoms in the carbon chain or in the carbon ring and may be substituted by 1 to 3 C₁-C₄ alkyl or alkoxy groups, R¹ or R² can stand for a hydrogen atom,

or R¹ or R² together form a bridge of 2 to 14 carbon atoms, it also being possible for some of the carbon atoms to be part of an aromatic ring system.

The variable A in formulae I and II is preferably a hydrocarbon chain of 2 to 8 carbon atoms and n is preferably 2.

The radicals R¹ and R² are each preferably a hydrogen atom or a C₁ to C₆ alkoxy group. In the case of the hydrogen atom it is possible for only one of the radicals, R¹ or R², to be a hydrogen atom.

Examples of suitable compounds containing amino groups include ethylenediamine, propylenediamine, tetramethylenediamine, pentamethylenediamine, hexamethylenediamine, diethylenetriamine, triethylenetetramine, polyethyleneimines, partly hydrolyzed polyvinylformamides, ethylene oxide and propylene oxide adducts such as the Texaco “Jeffamines”, cyclohexanediamine, and xylylenediamine.

The compound having the functional groups may be added to the polymer A) or to the dispersion of the polymer at any point in time. In the aqueous dispersion there is as yet no crosslinking with the keto or aldehyde groups. Only in the course of drying does crosslinking occur on the coated substrate.

The amount of the compound having the functional groups is preferably such that the molar ratio of the functional groups to the keto and/or aldehyde groups of the polymer is 1:10 to 10:1, in particular 1:5 to 5:1, more preferably 1:2 to 2:1, and very preferably 1:1.3 to 1.3:1.

The weight fraction of B) is preferably 0.05 to 2, in particular 0.05 to 1, and very preferably 0.1 to 0.4 part by weight per 100 parts by weight of polymer A).

Polymer A), or the aqueous dispersion of the polymer, can be mixed in a simple way with compound B). The resulting mixture is stable on storage.

The pressure sensitive adhesives (PSAs) may be composed solely of the polymer or of the aqueous dispersion of the polymer A) and compound B).

The PSAs may comprise further additives: fillers, colorants, flow control agents, piasticizers, thickeners or tackifiers (tackifying resin), for example. Examples of tackifiers are natural resins, such as rosins and their derivatives formed by disproportionation or isomerization, polymerization, dimerization and/or hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g. coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, α-methylstyrene, and vinyltoluene.

Other compounds increasingly being used as tackifiers include polyacrylates which have a low molar weight. These polyacrylates preferably have a weight-average molecular weight M_{W} of less than 30 000. With preference the polyacrylates are composed of at least 60% by weight, in particular at least 80% by weight, of C₁-C₈ alkyl (meth)acrylates.

Preferred tackifiers are natural or chemically modified rosins. Rosins are composed predominantly of abietic acid or its derivatives.

The amount by weight of tackifiers is preferably from 5 to 100 parts by weight, with particular preference from 10 to 50 parts by weight, per 100 parts by weight of polymer (solids/solids).

Preferably the PSA comprises plasticizers.

Suitable examples include esters, preferably diesters of C₅ to C₈ dicarboxylic acids, especially adipic esters.

Adipic esters are preferred. Suitable adipic esters are obtainable, for example, under the trade name Plastomoll® DNA (diisononyl adipate).

The PSAs are used for producing self-adhesive articles, such as labels, adhesive tapes or adhesive sheets, e.g., protective films.

The self-adhesive articles are generally composed of a backing with a layer of the adhesive applied to one or both sides, preferably to one side.

The backing material may comprise, for example, paper or preferably polymer films made of polyolefins or PVC, and with particular preference plasticized PVC.

By plasticized PVC is meant polyvinyl chloride which includes plasticizers and has a reduced softening temperature. Examples of customary plasticizers include phthalates, epoxides, and adipic esters. The amount of plasticizers in the plasticized PVC is generally more than 10% by weight and in particular more than 20% by weight.

With plasticized PVC, plasticizers can migrate into the film of adhesive layer and significantly impair its properties. With the adhesive of the invention, plasticizer migration has virtually no effect, if any at all, on the properties of the adhesive.

To produce the adhesive layer on the backing material, the backing material can be coated conventionally. Customary application rates are, for example, 5 to 40 g/m² (solids, without water).

The coated substrates comprised are used, for example, as self-adhesive articles, such as labels, adhesive tapes or sheets, e.g., protective films, and in particular printed sheets for decorative purposes. The articles are also suitable for outdoor applications, for example, on vehicles of all kinds.

The self-adhesive articles of the invention have good performance properties.

In particular, after bonding to any of a very wide variety of substrates, they can be detached again without residue, even at low temperatures below +5° C. or below 0° C. For this purpose they have reduced adhesion but good cohesion.

The properties remain good even where the backing material is plasticized PVC.

Haziness in the adhesive layer as a result of moisture exposure (i.e., blushing) is observed barely if at all. Consequently, the adhesive layer is highly water resistant.

### EXAMPLES

### A) Ingredients

### Polymer 1:

### Emulsion Polymer

69 parts by weight n-butyl acrylate (BA)
30 parts by weight 2-ethylhexyl acrylate (EHA)
1 part by weight acrylic acid (AA)
0.4 part by weight diacetone acrylamide (DAAM)
Emulsifier: 1 part by weight Disponil® FES77 (fatty alcohol ether sulfate)
0.5 part by weight Lumiten® l-SC (sulfosuccinic ester)

### Polymer 2 (For Comparison):

62 parts by weight BA
28 parts by weight EHA
5 parts by weight methyl acrylate (MA)
3 parts by weight methyl methacrylate (MMA)
2 parts by weight AA
0.4 part by weight butanediol diacrylate (BDA, crosslinker)

### Compound B)

Adipic Dihydrazide (ADDH) Crosslinked with DAAM

### Plasticizer

### Plastomoll® DNA (Adipic Ester)

### B) Preparation of the Pressure Sensitive Adhesives

The further constituents (see table) were added to the aqueous dispersions of polymers 1 and 2.

### C) Performance Tests

The PSAs were coated onto plasticized PVC film (from Renolit) at a rate of 25 g/m² (dry, without water) and the coated films were dried at 90° C. for 3 minutes.

Thereafter the peel strength (adhesion) was measured.

For the determination of the peel strength (adhesion), a 2.5 cm wide test strip was adhered in each case to a glass test element and was rolled on once with a roller weighing 1 kg. After 20 minutes, it was clamped by one end into the upper jaws of a tension-elongation testing apparatus. The adhesive strip was peeled from the test area at an angle of 180° and a speed of 300 mm/min; i.e., the adhesive strip was bent over and peeled off parallel to the metal test panel, and the force required to do this was measured. The measure of the peel strength was the force, in N/2.5 cm, which resulted as the average value from five measurements. The test was likewise carried out under standard conditions.

The tests of the peel strength were repeated following storage under hot conditions. Storage of the test assemblies under hot conditions (3 days, 70° C.) is intended to simulate accelerated aging of the samples and so to bring about forced migration of the plasticizer from the PVC backing into the adhesive layer.

Water Resistance (Blushing)

The test strips were suspended in a water bath. The hazing of the film of adhesive was observed over time. The point in time at which marked hazing became evident was recorded. The longer the time, the better the water resistance.

Peel Removal Behavior on Glass?

The coated PVC film was adhered to a glass plate at 0° C. and peeled off again by hand. The peel removal behavior was assessed.

TABLE
Test results

| | | | | Peel strength after | Residues after |
|---|---|---|---|---|---|
| | | | Peel strength | 3 days' storage of | bonding to and |
| | | Peel | on glass after | the laminate at 70° C., | detachment from |
| | | removal | 24 h storage | then bonding to glass | glass, painted metal |
| PSA (parts by | Blushing | at 0° C. | of the bond at | and 24 h storage of | panel or poly- |
| weight) | after | from glass | RT (N/25 mm) | the bond at RT (N/25 mm) | carbonate |
| 100 Polymer 1 | 30 min. | Soft | 5 N | 2 N | No |
| (solids) | | | | | |
| 0.2 ADDH | | | | | |
| 100 Polymer 1 | 30 min. | Very soft | 3 N | 1 N | No |
| (solids) | | | | | |
| 0.2 ADDH | | | | | |
| 3 Plastomoll | | | | | |
| 100 Polymer 2 | 30 min. | Soft | 5 N | 0.5 N | Yes |
| (solids) | | | | | |

1: A self-adhesive article comprising at least one backing and a pressure sensitive adhesive comprising
A) a polymer synthesized from
a) 50 to 99.5% by weight of butyl acrylate
b) 0 to 40% by weight of 2-ethylhexyl acrylate
c) 0 to 5% by weight of an ethylenically unsaturated acid
d) 0.1 to 5% by weight of an ethylenically unsaturated compound having at least one keto or aldehyde group
e) 0 to 30% by weight of further monomers and
B) a compound which comprises at least two functional groups which with the keto or aldehyde groups enter into a crosslinking reaction.

2: The self-adhesive article according to claim 1, wherein the polymer
A) is synthesized from
a) 50 to 85% by weight of butyl acrylate
b) 10 to 40% by weight of 2-ethylhexyl acrylate
c) 0 to 5% by weight of an ethylenically unsaturated acid
d) 0.1 to 2% by weight of an ethylenically unsaturated compound having at least one keto or aldehyde group
e) 0 to 10% by weight of further monomers.

3: The self-adhesive article according to claim 1, wherein polymer A) is an emulsion polymer.

4: The self-adhesive article according to claim 1, wherein the functional groups of compound B) are hydrazide, hydroxylamine, oxime ether, or amino groups.

5: The self-adhesive article according to claim 1, wherein compound B) comprises dicarboxylic dihydrazides.

6: The self-adhesive article according to claim 1, wherein the backing is composed of plasticized PVC.

7: The self-adhesive article according to claim 1, which is a self-adhesive sheet made of plasticized PVC.

8: The self-adhesive article according to claim 1, which is redetachable without residue.

9: A method for producing self-adhesive articles, wherein a plasticized PVC backing is coated with a pressure sensitive adhesive comprising
A) a polymer synthesized from
a) 50 to 99.5% by weight of butyl acrylate
b) 0 to 40% by weight of 2-ethylhexyl acrylate
c) 0 to 5% by weight of an ethylenically unsaturated acid
d) 0.1 to 5% by weight of an ethylenically unsaturated compound having at least one keto or aldehyde group
e) 0 to 30% by weight of further monomers and
B) a compound which comprises at least two functional groups which with the keto or aldehyde groups enter into a crosslinking reaction.
